(19) United States
(12) Patent Application Publication
(10) Pub. No.: US 2015/0336824 A1
(43) Pub. Date: Nov. 26, 2015

(54) WATER INTEGRITY IN TREATMENT AND DISTRIBUTION SYSTEMS

(71) Applicants: Jim SHUBAT, Ottawa (CA); Ludo FEYEN, Heusden-Zolder (BE)

(72) Inventors: Jim SHUBAT, Ottawa (CA); Ludo FEYEN, Heusden-Zolder (BE)

(21) Appl. No.: 14/094,754

(22) Filed: Dec. 2, 2013

(51) Int. Cl. C02F 1/72; C02F 1/00

(52) U.S. Cl. CPC C02F 1/722; C02F 1/008; C02F 2307/14; C02F 2305/023; C02F 2103/02

(57) ABSTRACT

As a measure of water integrity in water treatment and distribution systems, stabilized hydrogen peroxide is used as the secondary disinfectant. The concentration of hydrogen peroxide is monitored throughout the system and, if needed, additional hydrogen peroxide is injected into the system to maintain the level at established standards.

### FIELD OF INVENTION

The present invention relates to water treatment and distribution systems. More particularly, the invention relates to maintaining water integrity in water treatment and distribution systems with stabilized hydrogen peroxide solutions as the secondary disinfectant.

### BACKGROUND

Stabilized hydrogen peroxide solutions used for water disinfection, such as HUWA-SAN™ owned by Roam Chemie NV of Houthalen, Belgium, and SANOSIL™ owned by Sanosil Ltd. of Hombrechtikon, Switzerland are known in the art. Such hydrogen peroxide solutions are proprietary and are stabilized by silver ions or silver colloid in minute concentrations. Depending on the solution, the silver prevents the hydrogen peroxide from oxidizing too quickly when it contacts water, thereby allowing the solution to mix with the water before binding to and disinfecting undesirable microorganisms and chemicals.

Primary disinfection in water treatment systems has the objective of applying at or shortly after the source a disinfectant to destroy or inactivate pathogenic organisms in untreated water. Secondary disinfectant has the objective of applying to treated water, that is water which is already treated by a primary disinfectant, another disinfectant to preserve the integrity of the water in the distribution system.

One accepted disinfectant in secondary disinfectant is the maintenance of chlorine residual in the distribution system. This may be free chlorine (stronger) or chloramines (weaker), both of which have disadvantages. Chlorine drawbacks include the production of disinfectant by-products such as trihalomethanes (THMs) and haloacetic acids, chlorite and bromate. Chloramines are weaker oxidants than chlorine, resulting in fewer regulated by-products, however their use indirectly results in increased corrosion of lead and copper in the pipe system. It is also known that the effectiveness of chlorine as a disinfectant diminishes with an increase in the water's pH and a decrease in temperature.

Alternatives to chlorine products are needed as secondary disinfectants in order to maintain water integrity in treatment and distribution systems, regardless of pH and temperature fluctuations, and without resulting in undesirable by-products.

### SUMMARY OF THE INVENTION

A water treatment system is disclosed which comprises a primary disinfectant apparatus for disinfecting source water. Downstream, a first dosing apparatus inject stabilized hydrogen peroxide into the system. A first monitoring apparatus measures the concentration of hydrogen peroxide residual to ensure it is within established parameters. One or more further monitoring apparatus measure the concentration of hydrogen peroxide residual downstream of the first monitoring apparatus. One or more further dosing apparatus are located proximate the one or more further monitoring apparatus. Each further dosing apparatus is configured to inject stabilized hydrogen peroxide into the system the measured level is not within established parameters. A network of pipes connects the source water to the primary disinfectant apparatus, the primary disinfectant apparatus to the first dosing apparatus, the first dosing apparatus to the first monitoring apparatus, the first monitoring apparatus to the one or more further monitoring apparatus and the one or more further monitoring apparatus to the one or more further dosing apparatus.

In one embodiment, the first monitoring apparatus and the one or more further monitoring apparatus measure the residual and transmit measured residual data to a control system. The first dosing apparatus and the one or more further dosing apparatus receive signals from the control system to dose stabilized hydrogen peroxide, if needed. The control system monitors changes in measured residual data from two or more monitoring apparatus and compares the change to established standards.

In another embodiment, the control system transmits signals to dose an established amount of stabilized hydrogen peroxide to the one or more further dosing apparatus if a measured residual data has reached an established threshold.

In addition, a method of maintaining water integrity in a water treatment system is disclosed, comprising the steps of: disinfecting source water with a primary disinfectant, injecting stabilized hydrogen peroxide to the water, making a first measurement of the residual stabilized hydrogen peroxide in the water, then downstream, making a second measurement of the residual stabilized hydrogen peroxide in the water, and making a first determination whether the difference in the first and second measurements is within established standards.

In another embodiment, the method comprises injecting further stabilized hydrogen peroxide in the water if the difference in the first and second measurements is not within the established standards. In some embodiments, an alert is generated if the difference is not within the established standards.

In other embodiments, the method further comprises downstream, making one or more subsequent measurements of the residual stabilized hydrogen peroxide in the water and making a further determination whether the difference in two preceding measurements is within the established standards.

In yet other embodiments, the method further comprises injecting further stabilized hydrogen peroxide in the water if the difference in the two preceding measurements is not within the established standards.

### BRIEF DESCRIPTION OF THE DRAWINGS

Embodiments are illustrated by way of example and not limitation in the following figures, in which like references indicate similar elements.

FIG. 1 is a schematic of a prior art water treatment system which uses chlorine in the form of sodium hypochlorite as a secondary disinfectant;

FIG. 2 is a schematic of one embodiment of the water treatment system of the present invention which uses stabilized hydrogen peroxide as the secondary disinfectant; and

FIG. 3 is a process showing how the apparatus in the system communicate with the control system.

### DETAILED DESCRIPTION

Example embodiments, as described below, may be used to provide water treatment and distribution systems using stabilized hydrogen peroxide as a secondary disinfectant.

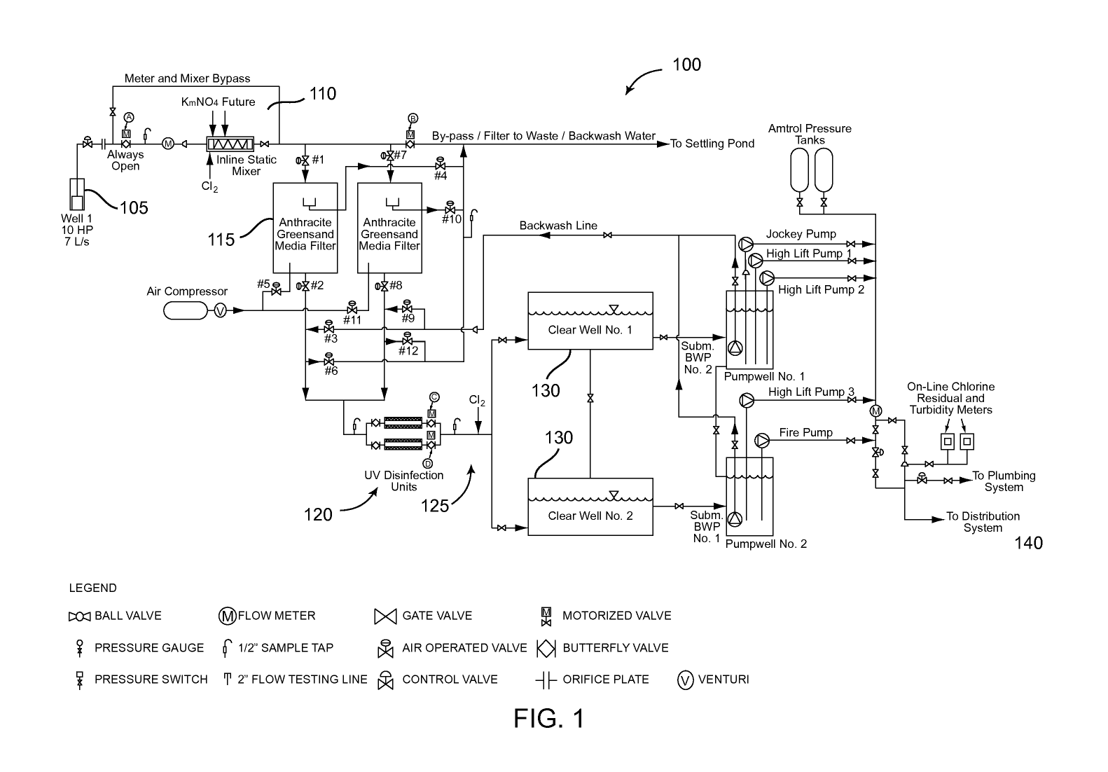

FIG. 1 shows a schematic prior art municipal water treatment system 100. Well water 105 undergoes pre-treatment with KMnNO₄ and sodium hypochlorite 110 in order to oxidize the dissolved iron and manganese, followed by exposure to anthracite greensand media contactors 115 for iron and manganese removal. The pre-treated water is then disinfected using ultra-violet (UV) units 120 as the primary disinfectant. Treated water is then fed with sodium hypochlorite 125 as the secondary disinfectant before being directed to an in-ground storage reservoir consisting of two clear wells 130 where the water remains for several days until is needed in distribution. Biofilms can be produced in the clear wells 130 which can be cause for disinfection by-product formation together with naturally occurring organics in the water. The water was eventually pumped, as needed, into the water distribution system 140. Every time the level of trihalomethanes exceeded the regulated standard, a health risk is present. The distribution system needed to be flushed and treated water was wasted.

THM levels measured after contactors 115 and before the clear wells 130 were below 15 μg/L. In the clear wells 130, the measured THM levels ranged from 104 to 112 μg/L. The results suggested that elimination of the secondary disinfectant (sodium hypochlorite 125) which entered clear wells 130 would be required to reduce the THM levels.

Stabilized hydrogen peroxide was found to be a suitable replacement as a secondary disinfectant as described herein. Unlike chlorine products, stabilized hydrogen peroxide solutions have effective disinfectant characteristics that are not influenced by expected changes in temperature or pH.

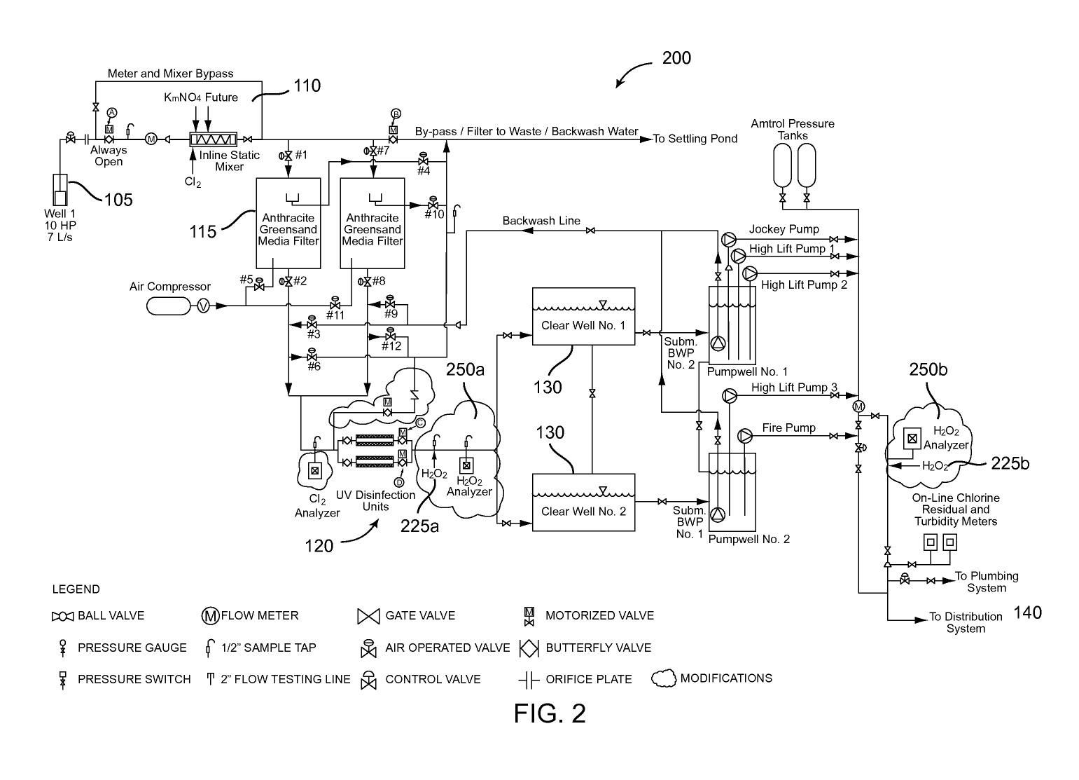

In one embodiment, as shown in FIG. 2, the municipal water treatment system 200 was modified to remove the chlorine dosing (125 from FIG. 1) and replaced with a first dosing apparatus 225a of a suitable quantity of stabilized hydrogen peroxide solution. In one embodiment, HUWA-SAN™ 25% was used. Other stabilized hydrogen peroxide solutions are contemplated. Prior to entering the clear wells 130, water samples are continuously drawn to measure the concentration of hydrogen peroxide residual with monitoring apparatus 250a. The treated and peroxygenated water enters the clear wells 130. After exiting the clear wells 130, the water is pumped, as needed, towards the distribution system. Prior to entering the distribution system, water samples are continuously drawn to measure the concentration of hydrogen peroxide residual with monitoring apparatus 250b.

The measured level of hydrogen peroxide from monitoring apparatus 250a is compared with the measured level from monitoring apparatus 250b. The measured level monitoring apparatus 250b is expected to be the same or lower than the measured level in monitoring apparatus 250a, the change resulting from oxygenation (ie: disinfecting) which occurred between the two monitoring apparatus 250a, 250b.

If the measured level remains within the established guidelines of hydrogen peroxide for the given application, such as between 3-8 ppm (Ontario, Canada), the water is then transported to the distribution system. If however the measure level falls to or below the lower limit, a second dosing apparatus 225b of stabilized hydrogen peroxide solution injects a suitable amount of stabilized hydrogen peroxide solution to the water in order to raise the concentration of hydrogen peroxide to within acceptable standards. Optionally, an alert may be generated, such as a sound, communication or flashing light to warn personnel of additional dosing.

For example, if the level of hydrogen peroxide measured by monitoring apparatus 250a is 7 ppm and the level of hydrogen peroxide measured by monitoring apparatus 250b is 3 ppm, resulting in a 4 ppm delta, this suggests that a large amount of hydrogen peroxide has been oxidized in the system perhaps at the clear wells 130 or in the interconnecting piping. In this instance, since the measured amount by monitoring apparatus 250b is at or near the lower limit, second dosing apparatus 225b could be configured to automatically dose additional hydrogen peroxide to raise the concentration level to, for example 6 ppm prior to entering the distribution system.

In a similar manner, additional monitoring apparatus 250c, 250d, 250e, etc may be placed in the distribution system to monitor the concentration of hydrogen peroxide in a continuous manner at specific locations in the system, such as at junctions, pumps, water towers, neighbourhoods, commercial buildings, industrial buildings and residences. Additional locations may be where there is a concern about stagnant water or when additions or modifications are being made to the system's piping.

In larger distribution systems which are, for example several kms in length, additional dosing apparatus 225c, 225d, 225e, etc may be placed downstream a respective monitoring apparatus 250c, 250d, 250e, etc to inject hydrogen peroxide on an as needed basis so as to satisfy the standard and maintain water integrity. In a system which has not been compromised, the one or more dosing apparatus serves as an emergency station. In some embodiments, there are more monitoring apparatus and only a few dosing apparatus. In other embodiments, each monitoring apparatus is paired with a dosing apparatus. In still other embodiments, an apparatus may comprise both the monitoring and dosing functions.

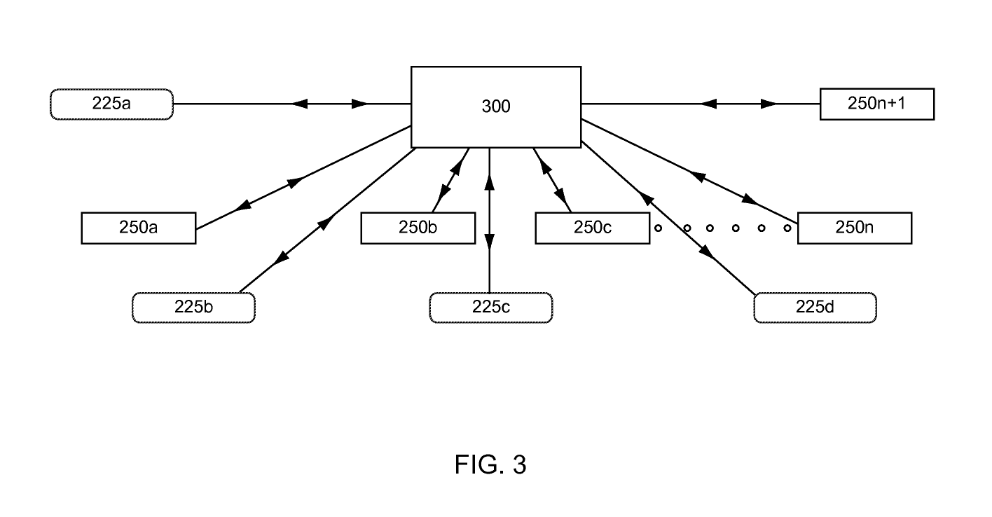

Each monitoring apparatus 250a, 250b, 250c, 250d, 250e, etc and each dosing apparatus 225a, 225b, 225c, 225d, 225e, etc are connected to the water treatment control system 300 either by wired or wireless connections so that data of measurements and dosing amounts are continuously relayed to and/or from control system 300, as shown in FIG. 3. Upon receiving data from a monitoring apparatus which is indicative of a drop in residual that may require dosing, the control system 300 transmits appropriate signals to the appropriate dosing apparatus to inject a suitable amount of hydrogen peroxide into the system so as to raise the concentration of hydrogen peroxide in the system to an acceptable level.

If an unexpected delta in hydrogen peroxide residual between two adjacent monitoring apparatus 250n, 250n+1 were to be received by control system 300, appropriate alerts are sent to investigate or remedy the problem. Furthermore, trending data over time may reveal a gradual increase in deltas between any two given monitoring stations, which may signify the introduction of contaminants that are being oxidized.

One embodiment is a system comprising first monitoring apparatus 250a and first dosing apparatus 225a, both located before the clear wells; second monitoring apparatus 250b and second dosing apparatus 225b, both located before the beginning of the distribution system; and monitoring apparatus 250c located at the first connection in the distribution system, about 1.5 km away.

It is contemplated to add further monitoring apparatus at multiple connections in the distribution system. It is further contemplated to add further dosing apparatus at multiple connections in the distribution system. The monitoring and dosing functions may be part of one apparatus. Placement locations in the distribution system include at the connection for a residence, a building, a neighbourhood, a water tower, etc.

Over a first 31-day period, just after changeover from a chlorine-based secondary disinfectant to a stabilized hydrogen peroxide-based secondary disinfectant, minimum hydrogen peroxide residuals were measured every day at each monitoring apparatus 250a, 250b, 250c. An average of about 12 ppm was measured at monitoring apparatus 250a, an average of about 9 ppm was measured at monitoring apparatus 250b an average of about 6 ppm was measured at monitoring apparatus 250c.

As the peroxide demand dropped through the remediation of low level biofilm in distribution, less hydrogen peroxide dosing was required. Eight months later, over a 31-day period, at the same locations, an average of about 6 ppm was measured at monitoring apparatus 250a, an average of about 6 ppm was measured at monitoring apparatus 250b an average of about 5 ppm was measured at monitoring apparatus 250c. The readings at monitoring apparatus 250c, which was located in the distribution network, ranged from about 4 ppm to about 6 ppm which was within the accepted standard. In addition, the smaller drop in consumed hydrogen peroxide between adjacent monitoring apparatus confirmed that less hydrogen peroxide was being oxidized in the water treatment system and by the first connection point of the distribution system.

In comparison with the THM levels described in the system of FIG. 1, since the system of FIG. 2 was started, monthly levels of THMs ranged from 21-26 μg/L with an average of 24 μg/L. The replacement of chlorine with stabilized hydrogen peroxide as a secondary disinfectant in the system resulted in a drastic reduction in THMs.

In addition to THMs, all other measured test parameters were within acceptable levels, including lead, copper, pH, ATP (biofilm), heterotrophic plate count, legionella pneumophila.

The use of stabilized hydrogen peroxide as a replacement to chlorine and chloramines as a secondary disinfectant, together with the continuous monitoring and dosing system provides a measure of water integrity in the water treatment and distribution system while reducing the level of disinfectant by-products including THMs.

While the invention has been described with respect to a water treatment system and distribution system that for a community, it may equally be applied to other systems, including for industrial buildings, commercial buildings, hotels, multi-tenant residences, hospitals, agricultural applications, and the like.

1. A water treatment and distribution system comprising:
a. a primary disinfectant apparatus for disinfecting source water;
b. a first dosing apparatus to inject stabilized hydrogen peroxide into the system;
c. a first monitoring apparatus to measure the concentration of hydrogen peroxide residual;
d. one or more further monitoring apparatus to measure the concentration of hydrogen peroxide residual downstream of the first monitoring apparatus;
e. one or more further dosing apparatus proximate the one or more further monitoring apparatus, each capable of injecting stabilized hydrogen peroxide into the system; and
f. a network of pipes connecting the source water to the primary disinfectant apparatus, the primary disinfectant apparatus to the first dosing apparatus, the first dosing apparatus to the first monitoring apparatus, the first monitoring apparatus to the one or more further monitoring apparatus and the one or more further monitoring apparatus to the one or more further dosing apparatus.

2. The system of claim 1, wherein the first monitoring apparatus and the one or more further monitoring apparatus measure the residual and transmit measured residual data to a control system.

3. The system of claim 2, wherein the first dosing apparatus and the one or more further dosing apparatus receive signals from the control system to dose stabilized hydrogen peroxide.

4. The system of claim 2, wherein the control system monitors changes in measured residual data from two or more monitoring apparatus and compares the change to established standards.

5. The system of claim 4, wherein the control system transmits signals to dose an established amount of stabilized hydrogen peroxide to the one or more further dosing apparatus if a measured residual data has reached an established threshold.

6. The system of claim 1, wherein at least one of the one or more further monitoring apparatus is located at a first or subsequent connection in the distribution system.

7. The system of claim 1, wherein at least one of the one or more further dosing apparatus is located at a first or subsequent connection in the distribution system.

8. A method of maintaining water integrity in a water treatment system, comprising:
a. disinfecting source water with a primary disinfectant;
b. injecting stabilized hydrogen peroxide to the water;
c. making a first measurement of the residual stabilized hydrogen peroxide in the water;
d. downstream, making a second measurement of the residual stabilized hydrogen peroxide in the water; and
e. making a first determination whether the difference in the first and second measurements is within established standards.

9. The method of claim 6 further comprising injecting further stabilized hydrogen peroxide in the water if the difference is not within the established standards.

10. The method of claim 6 wherein an alert is generated if the difference is not within the established standards.

11. The method of claim 6 further comprising:
f. downstream, making one or more subsequent measurements of the residual stabilized hydrogen peroxide in the water; and
g. making a further determination whether the difference in two preceding measurements is within the established standards.

12. The method of claim 9 further comprising injecting further stabilized hydrogen peroxide in the water if the difference in the two preceding measurements is not within the established standards.
